(19) United States
(12) Patent Application Publication
(10) Pub. No.: US 2007/0074155 A1
(43) Pub. Date: Mar. 29, 2007

(54) APPARATUS AND METHOD FOR DATA PROFILE BASED CONSTRUCTION OF AN EXTRACTION, TRANSFORM, LOAD (ETL) TASK

(75) Inventors: Ronaldo AMA, Palo Alto, CA (US); Sachinder S. Chawla, Palo Alto, CA (US); Awez Syed, San Jose, CA (US); Kirubakaran Pakkirisamy, San Ramon, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/534,577

(22) Filed: Sep. 22, 2006

Related U.S. Application Data
(60) Provisional application No. 60/719,958, filed on Sep. 23, 2005.

(51) Int. Cl. G06F 9/44; G06F 9/45

(52) U.S. Cl. 717/106; 717/136

(57) ABSTRACT

A computer readable storage medium includes executable instructions to accept a specification of an Extraction, Transformation, Load (ETL) task associated with source data. Source data is profiled to produce profiled data. Data conformance rules are defined from the profiled data. Mapping rules are generated in accordance with the collaborative specification and data conformance rules. The mapping rules are utilized to create an ETL task.

### CROSS REFERENCE TO RELATED APPLICATIONS

This application claims the benefit of U.S. Provisional Application Ser. No. 60/719,958, entitled “Apparatus and Method for Automated Data Integration,” filed Sep. 23, 2005, the contents of which are hereby incorporated by reference in their entirety.

### BRIEF DESCRIPTION OF THE INVENTION

This invention relates generally to data processing in a networked environment. More particularly, this invention relates to data profile based construction of an Extraction, transform, Load (ETL) task to facilitate automated data integration.

### BACKGROUND OF THE INVENTION

The process of migrating data from a source (e.g., a database) to a target (e.g., another database, a data mart or a data warehouse) is sometimes referred to as Extract, Transform and Load, or the acronym ETL. ETL tools help users implement data integration solutions.

To design data integration implementations properly, there are two important steps. The first step is to obtain a thorough understanding of the source systems from which data needs to be extracted. Unfortunately, the limited and ad hoc tools available for scrutinizing source systems makes thorough understanding difficult. In addition, one individual typically does not have expertise in a number of source systems. Current tools do not facilitate the sharing of expert knowledge regarding a variety of source systems.

A second important step in data design integration is mapping from the source systems to the intended target system. Current mapping techniques operate without a full understanding of the data within data sources, in particular, without a full understanding of data anomalies, inconsistencies, and redundancies.

Existing data integration tools do not readily support project management and collaboration. There are general project management tools, but they are not designed specifically for ETL projects. Furthermore, general project management tools do not produce output that can be directly applied to an ETL task processor.

In view of the foregoing problems associated with the prior art, it would be desirable to establish an improved technique for creating ETL tasks. In particular, it would be desirable to provide a data source aware technique to generate ETL tasks.

### SUMMARY OF THE INVENTION

The invention includes a computer readable medium with executable instructions to accept a specification of an Extraction, Transformation, Load (ETL) task associated with source data. Source data is profiled to produce profiled data. Data conformance rules are defined from the profiled data. Mapping rules are generated in accordance with the specification and data conformance rules. The mapping rules are utilized to create an ETL task. .

The invention provides both a collaborative system for composing the model for a data integration process and back end functionality that enforces validation rules and logic for the join conditions that will be applied in the ETL job that is generated. The invention offers an innovative approach to effectively create ETL jobs for a data integration project. The invention supports projects based on both relational and hierarchical data.

### BRIEF DESCRIPTION OF THE FIGURES

The invention is more fully appreciated in connection with the following detailed description taken in conjunction with the accompanying drawings, in which:

FIG. 1 illustrates a computer configured to support operations associated with the invention.

FIGS. 2 illustrates processing operations associated with an embodiment of the invention.

FIG. 3 illustrates a project management GUI associated with an embodiment of the invention.

FIG. 4 illustrates a project specification GUI associated with an embodiment of the invention.

FIG. 5 illustrates a GUI for specifying a source in accordance with an embodiment of the invention.

FIG. 6 illustrates a GUI for specifying a target in accordance with an embodiment of the invention.

FIG. 7 illustrates a GUI for specifying data connections in accordance with an embodiment of the invention.

FIG. 8 illustrates table information annotated with expert commentary in accordance with an embodiment of the invention.

FIG. 9 illustrates profile data formed in accordance with an embodiment of the invention.

FIG. 10 illustrates mappings formed in accordance with an embodiment of the invention.

FIG. 11 illustrates the use of supplemental information to convey mapping information.

FIG. 12 illustrates mapping information associated with an embodiment of the invention.

FIG. 13 illustrates validated mappings associated with an embodiment of the invention.

FIG. 14 illustrates report information generated in accordance with an embodiment of the invention.

FIG. 15 illustrates the generation of a data flows from mappings in accordance with an embodiment of the invention.

FIG. 16 illustrates the generation of an ETL job in accordance with an embodiment of the invention.

Like reference numerals refer to corresponding parts throughout the several views of the drawings.

### DETAILED DESCRIPTION OF THE INVENTION

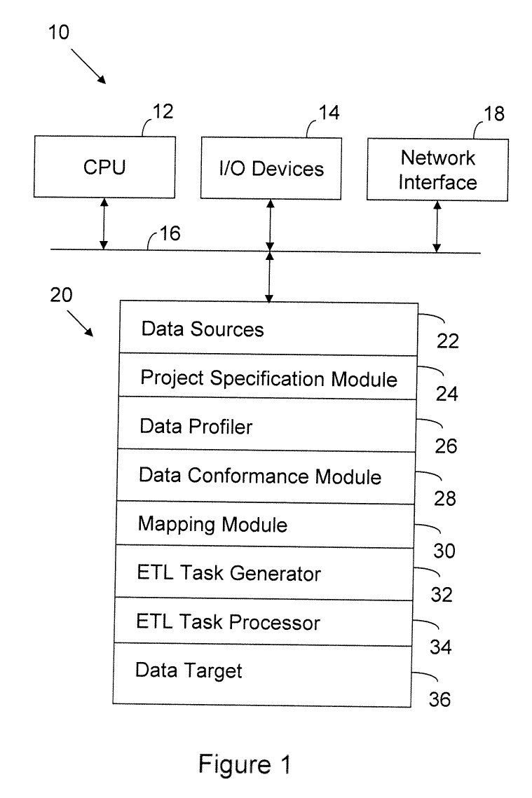

FIG. 1 illustrates a computer 10 configured in accordance with an embodiment of the invention. The computer 10 includes standard components, such as a central processing unit 12 connected to input/output devices 14 via a bus 16. The input/output devices 14 may include a keyboard, mouse, display, printer, and the like. A network interface circuit 18 is also connected to the bus 16. The network interface circuit 18 facilitates communications with a network (not shown). Thus, the computer 10 may operate in a client-server environment. In one embodiment, the computer 10 is an application server accessible by a large number of clients that request various tasks implemented in accordance with embodiments of the invention.

A memory 20 is also connected to the bus 16. The memory 20 includes data and executable instructions to implement operations associated with the invention. The memory 20 stores a set of data sources 22. The data sources 22 may include custom applications, relational databases, legacy data, customer data, supplier data, and the like. Typically, the data sources 22 are distributed across a network, but they are shown in a single memory 20 for the purpose of convenience.

The memory 20 also stores a project specification module 24. The project specification module 24 includes executable instructions to solicit user input regarding the specification or characterization of an ETL task. This specification may include task definition and task execution operations. As discussed below, the specification is used to construct an actual ETL task.

The input may be received from a single user. However, in many applications, the input is received by a large number of users working collaboratively. For example, for a given ETL job, a first expert associated with a first data source may provide input on the intricacies of the first data source, while a second expert associated with a second data source may provide input on the intricacies of the second data source. In one embodiment, the project specification module 24 includes executable instructions to solicit and receive information on a target data model, solicit and receive information on source systems, and executable instructions to analyze source systems. The project specification module 24 may also include executable instructions to solicit and receive business requirement definitions for a data integration task. In one embodiment, the project specification module 24 includes executable instructions to support web based input from clients. Further discussion and examples of user interfaces associated with the project specification module 24 are provided below.

The memory 20 also stores a data profiler 26. A standard data profiler 26 may be used to implement this task. The data profiler 26 produces profiled data which documents source data defects and anomalies. Database profiling is the process of analyzing a database to determine its structure and internal relationships. Database profiling assesses such issues as the tables used, their keys and number of rows. Database profiling may also consider the columns used and the number of rows with a value, relationships between tables, and columns copied or derived from other columns. Database profiling may also include analysis of tables and columns used by different applications, how tables and columns are populated and changed, and the importance of different tables and columns. The invention utilizes information from database profiling to generate an intelligent ETL strategy. For example, the ETL job may include transform rules based on outlying data. In addition to the transform rules based on outlying data, a logical data map may apply the data profile to determine which columns are relevant and the join structure that is implemented in the logical data map.

In one embodiment, the profiled data is processed by a data conformance module 28. The data conformance module 28 includes executable instructions to assess and characterize data quality within the data sources 22. The data conformance module 28 may also include executable instructions to define data quality rules. For example, the data conformance module 28 may include executable instructions to identify columns that are insignificant, duplicate or correlated. In each of these instances, a decision may then be made to omit such columns from a data target. The data conformance module 28 may also include executable instructions to determine keys on which tables can be joined and determine join relationships between tables. Various techniques may be used to generate data conformance rules. For example, a gender column may have 98% of its values be either M or F and the other 2% may be either NULL, blank or the character U. In this case, a rule is generated to enforce that all data read from the gender column must meet the validation criteria of “Gender=‘M’ OR Gender=‘F’”. Another example is that profiling a CUSTOMER_ID column determines that 90% of the values in the column have the 999999 pattern, i.e., they are 6 digit numbers. Therefore, a rule is generated to assert that CUSTOMER_ID must be between 100,000 and 999,999. These rules are then generated as data integration validation transform rules at the time that the data integration job is generated.

The data conformance module 28 may include executable instructions to implement conformance rules consistent with business requirement definitions received by the project specification module 24.

A mapping module 30 is also stored in memory 20. The mapping module 30 includes executable instructions to generate mapping rules in accordance with the project specification and the data conformance rules. Recall that the project specification includes information on data sources and a data target. The project specification mav also include additional detailed information about the data sources and data target which may be included in mapping operations.

A mapping captures the relationship between one or more columns in a source to the columns in a target table. This relationship is in a mapping expression and description. Each table that exists in the target data store defined for a project typically has a mapping or target table mapping. A mapping defines which tables from the data sources associated with a project populate the columns of the target table. Each column of the target table has a mapping expression that describes how it is populated. A target table can have more than one mapping in some situations. For example, one might have a mapping to describe how to populate a customer table from a first vendor and another mapping to define how to populate the table when the source is from a second vendor. One can also create a mapping that defines how to populate the table during an initial load and another mapping the defines the delta load for the table.

The mapping rules are processed by the ETL task generator 32 to produce an ETL task. This operation may be implemented with an ETL task generator 32. The ETL task generator includes executable code to define an ETL task consistent with the mapping rules.

An ETL task processor 34 subsequently executes the ETL task. The ETL task processor 34 may be a standard data integration tool. It is the input (i.e., the ETL task formed in accordance with the invention) that is significant. The ETL task processor 34 generates a data target 36, such as a data warehouse. Typically, the data target 36 would be on a separate machine, even though it is shown on the same machine in this example. Indeed, many or all of the modules of memory 20 may be distributed across a network. It is the operations of these modules that are significant, not how or where in a network they are implemented.

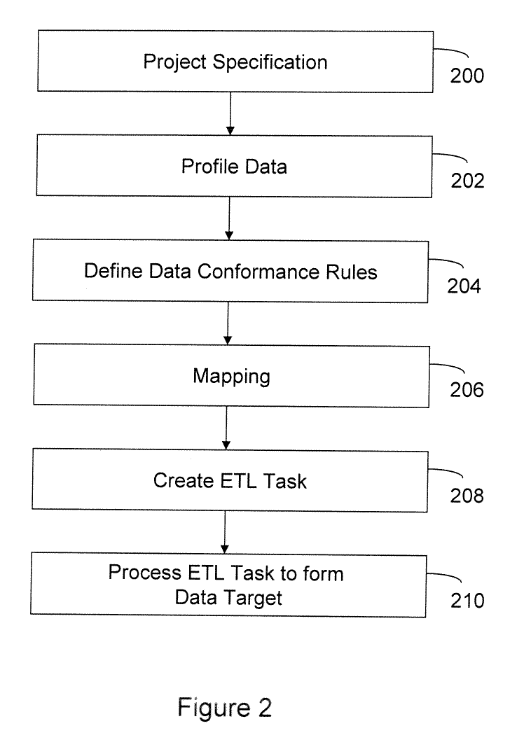

FIG. 2 illustrates processing operations associated with an embodiment of the invention. The first processing operation of FIG. 2 is project specification 200. This operation may be implemented with the project specification module 24. In addition, to the project specification tasks discussed above, this operation may also include specifying (heterogeneous) data sources, data connections, and a data target. The project specification 200 may be characterized by a single individual, but is commonly characterized by collaborating individuals, with different expertise.

Data is then profiled 202. The data profiler 26 may be used to implement this operation. The profiled data is used to identify data quality problems in the data sources. This information is then used in connection with the data conformance rules. Thus, the present invention uses profiled data to improve an ETL task.

Data conformance rules are then defined 204. The data conformance module 28 may be used to implement this operation. Mapping is then performed 206. The mapping module 30 may be used to implement this operation. In addition to the mapping operations discussed above, mapping may also include accepting attachments to characterize mapping rules, the specification of joins, and the specification of filter conditions. Further, the system may be configured such that an expert must first validate the mapping rules prior to their execution. The mapping operation may also be implemented such that the mapping module 30 generates mapping statistics, as discussed below.

An ETL task is then created 208. The ETL task generator 32 may be used to implement this operation. In one embodiment, the ETL task generator 32 creates a set of dataflow tasks, as discussed below. In each embodiment, the ETL task generator generates a an ETL task in accordance with specified mapping rules.

Finally, the ETL task is processed to form a data target 210. The ETL task processor 34 may be used to implement this operation. Commonly, the ETL task processor 34 is configured to produce a data warehouse.

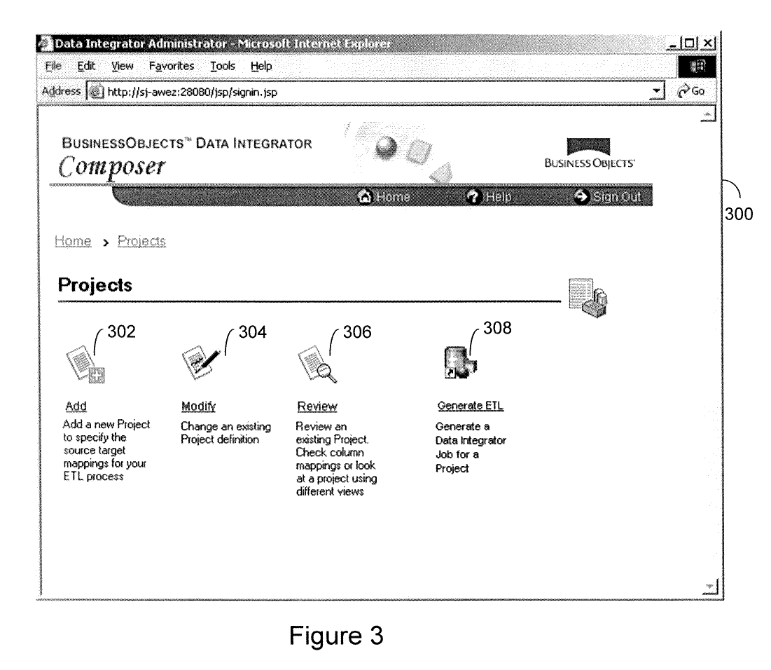

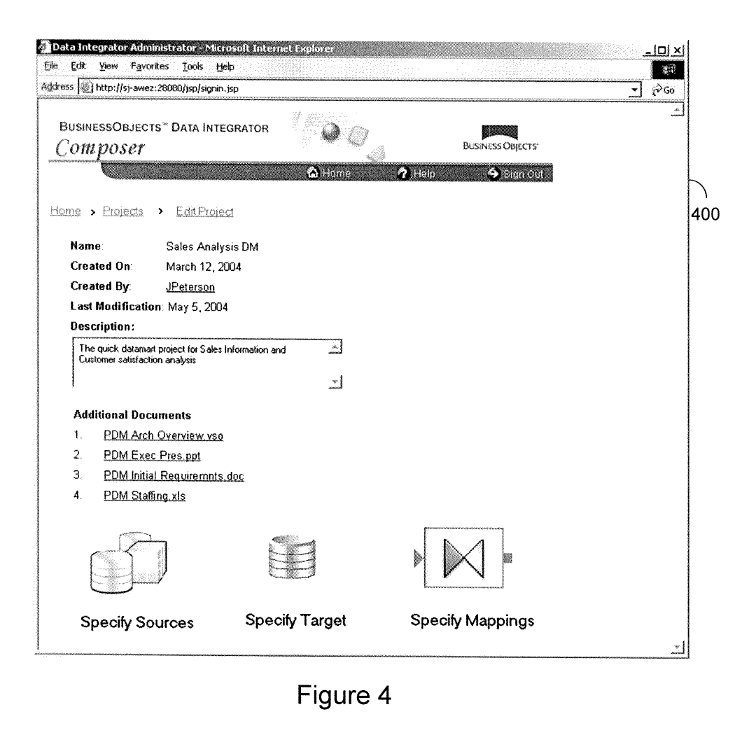

FIG. 3 illustrates a Graphical User Interface (GUI) 300 that may be used to allow one to add, modify, review and generate an ETL job. The GUI 300 may be associated with the project specification module 24. By way of example, if one elects to add a new project, the “add” icon 302 may be activated. This results in the GUI 400 of FIG. 4, which may also be supplied by the project specification module 24. This GUI facilitates the specification of sources, the specification of a target, and the specification or invocation of mappings. Additional documents may also be associated with the project. Additional information, such as a project description, a modification, date, a creator, a creation date, a name, etc. may also be supplied in the GUI 400.

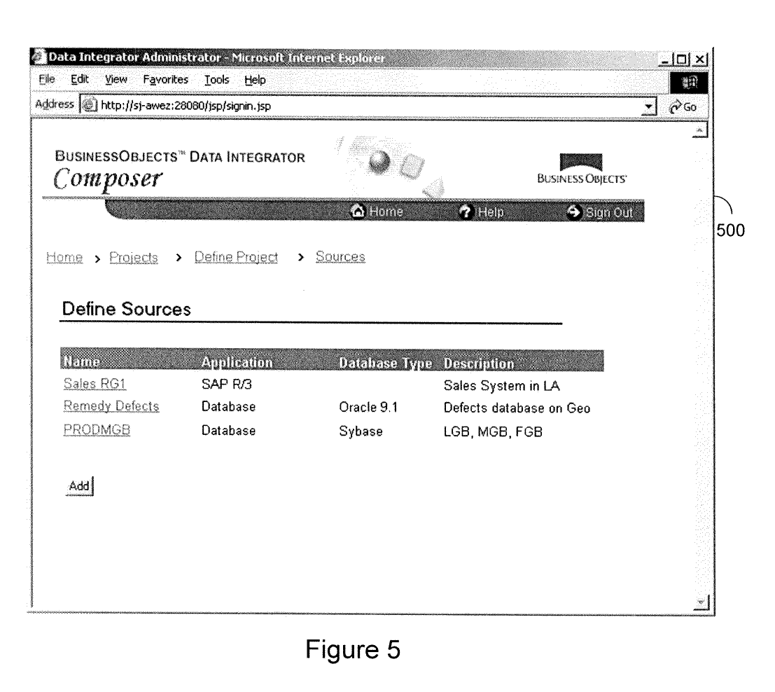

FIG. 5 illustrates an example of a GUI 500 which may be used to define sources. In this example, a source is defined with a name, application, database type and a description. This allows one to identify and define the sources and data that is relevant to a business intelligence project. Individual data source experts may specify the information for the data source that they know best, thereby facilitating collaborative efforts.

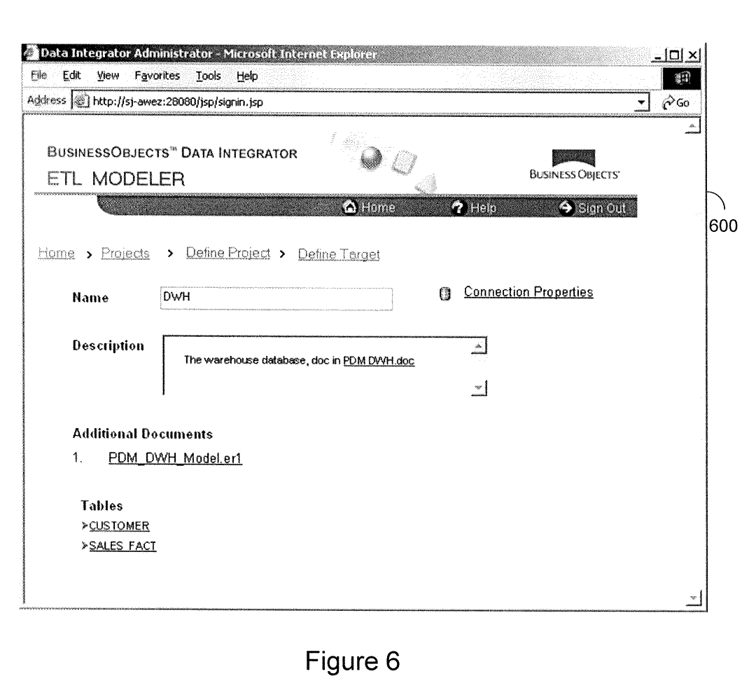

FIG. 6 illustrates an example of a GUI 600 which may be used to define a target. In this example, the GUI 600 allows specification of a name, description, and additional documents to be associated with the target.

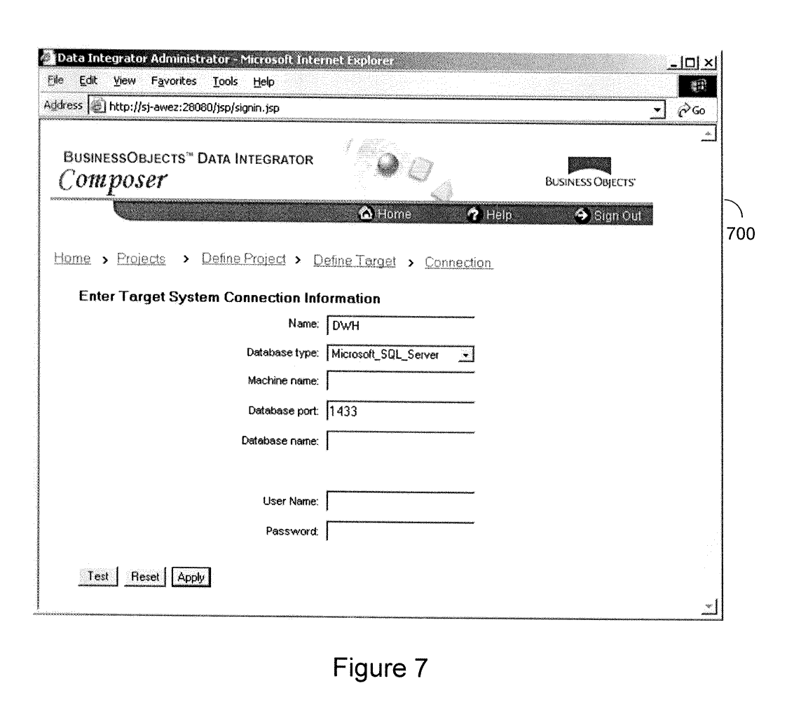

FIG. 7 illustrates an example of a GUI 700 which may be used to define connections to a target system. In this example, the connections to the target system are specified by one or more of a name, a database type, a machine name, a database port, and a database name. A user name and password may also be used to authenticate a user. Naturally, a user name and password may also be used with other GUIs disclosed herein.

After a new project is specified, such as with the GUIs of FIGS. 3-7, a user may modify or review the project. FIG. 3 illustrates icons to allow the modification (icon 304) and review (icon 306) of a project.

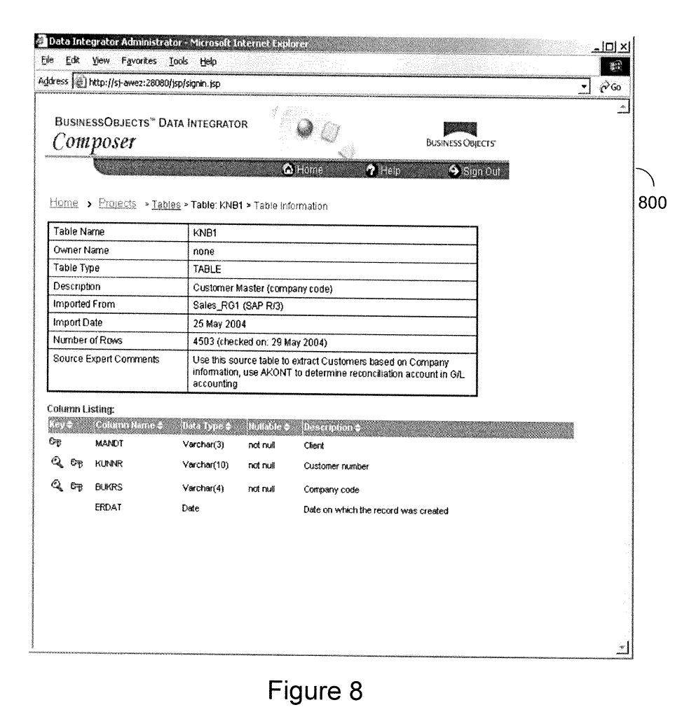

FIG. 8 provides an example of table information and metadata that may be reviewed or modified in accordance with an embodiment of the invention. GUI 800 of FIG. 8 provides information on a table name, owner name, table type, description, import information, number of rows and source expert comments. Further, the GUI 800 provides column information, such as key, column name, data type, nullability, and description. An individual with appropriate authorization may view and/or modify this information. This allows a user to better understand the data associated with an ETL task. In other embodiments of the invention, a user explores views of lineage, impact, and star schema.

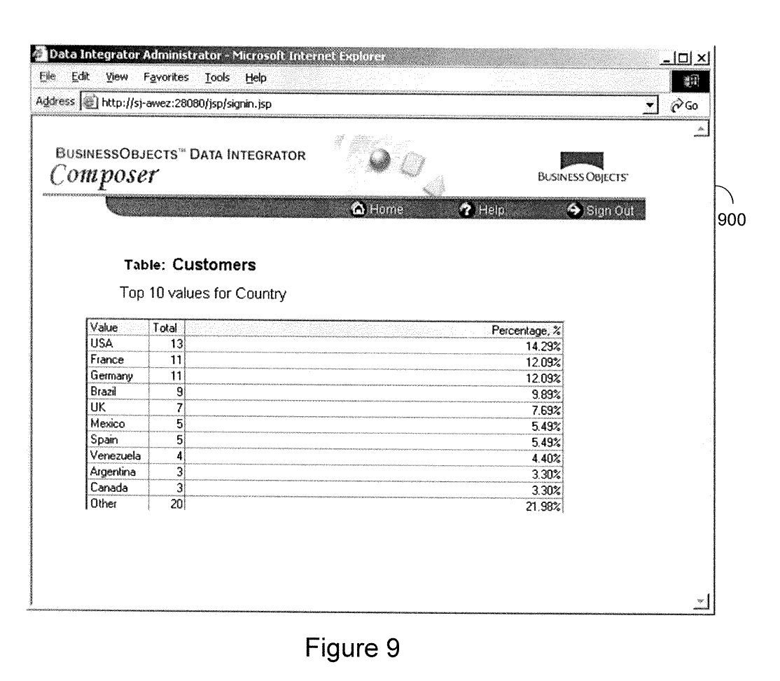

After project specification, the data profiler 26 is invoked to produce profiled data. FIG. 9 illustrates a GUI 900 depicting profiled data. In this example, the percentage total for various countries is provided. The “other” countries appear to have a relatively high percentage value, suggesting a data quality problem. Data profiling may also provide information such as low value, high value, null count, patterns and the like.

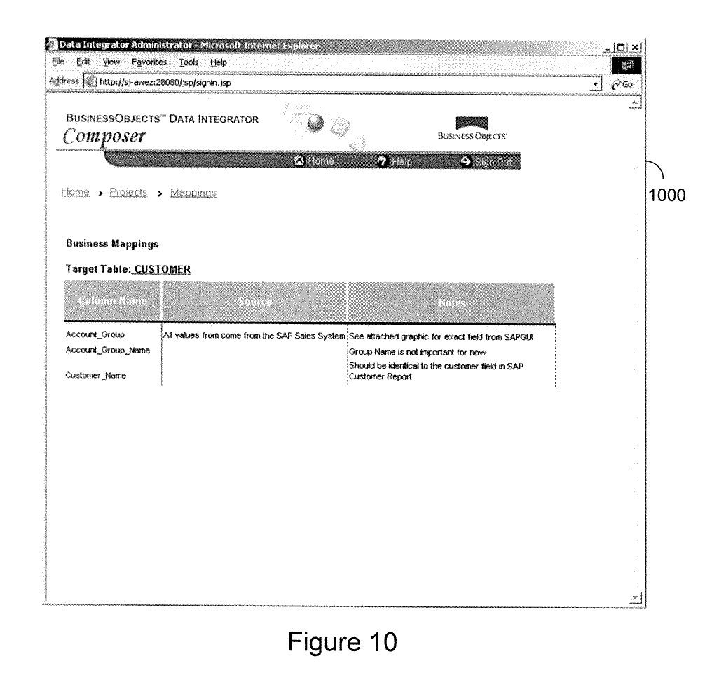

FIG. 10 illustrates a GUI 1000, which may be associated with the mapping module 30. The GUI 1000 supports mapping operations. In this example, mapping is specified for a target table “Customer”, which has various columns. “Account_Group”, “Account_Group_Name”, and “Customer_Name”. The GUI 1000 also specifies source information and includes an area for notes. The notes are typically from a domain expert.

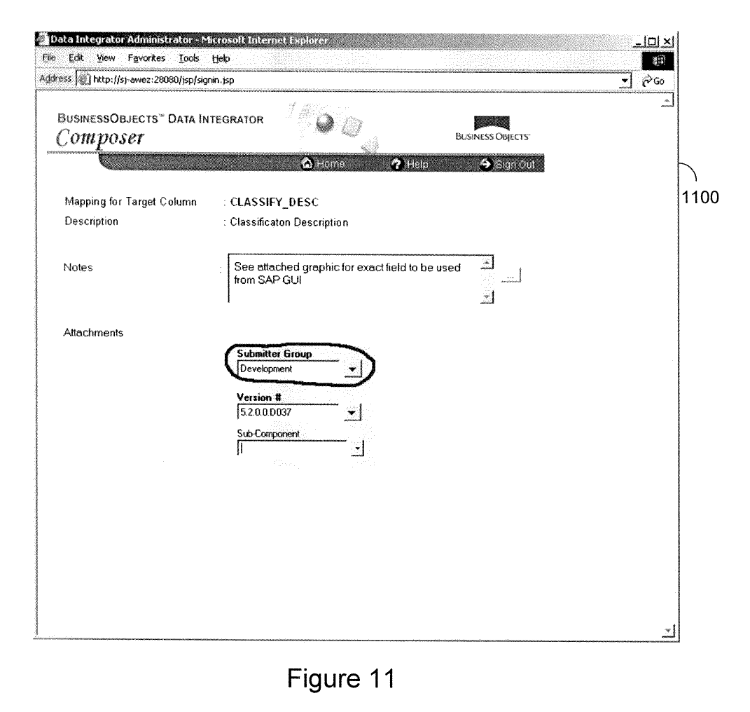

FIG. 11 illustrates a GUI 1100, which allows additional information to be associated with a mapping. In this example, the additional information may be in the form of notes and attachments. The attachments may include screenshots, links and pictures.

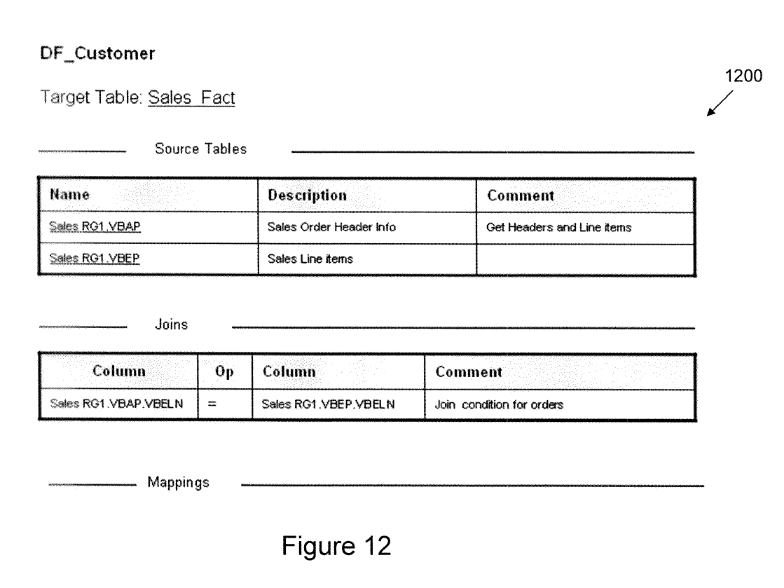

FIG. 12 illustrates an interface 1200 that may be used to specify joins. In particular, the figure specifies a target table “Sales Fact”. Source tables “SalesRG1.VBAP” and “SalesRG1.VBEP” are also specified. The source tables have associated descriptions and comments. The mapping in this example is a join operation. A similar interface may be used to specify filter conditions.

The mapping module 30 includes executable instructions to infer mapping relationships. For example, the name of the columns in the source and the target tables (i.e., project specification information) are used to infer a mapped relationship. These inferred relationships are combined with data conformance rules to create a logical mapping.

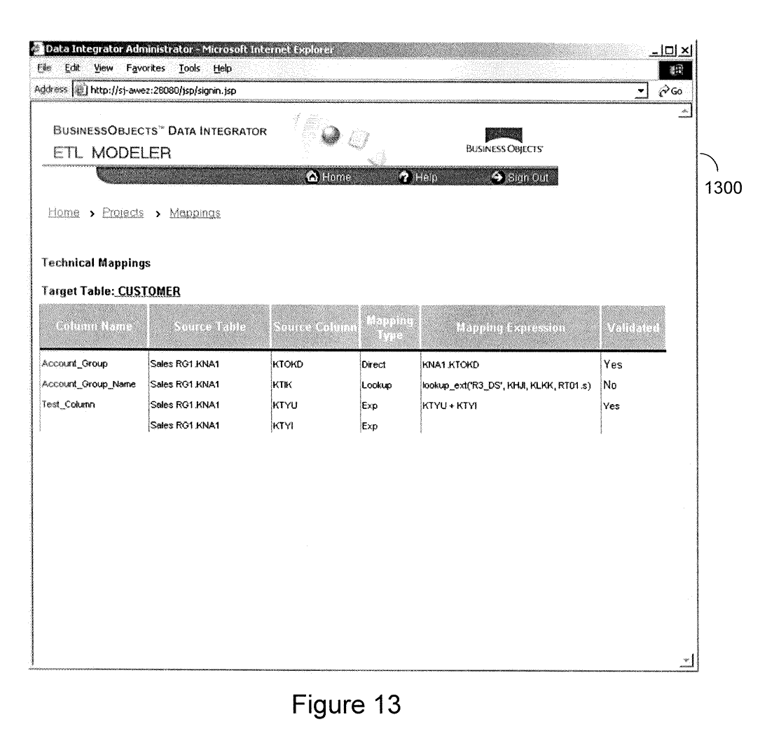

FIG. 13 illustrates an interface 1300 to solicit expert validation of a mapping through a “validated” column. In FIG. 13, a target table “Customer” is specified. The figure also illustrates a set of column names associated with a source table “SalesRG1.KNA1”. The figure also illustrates a mapping type and a mapping expression for each column. An expert relies upon this information to validate the proposed mapping strategy.

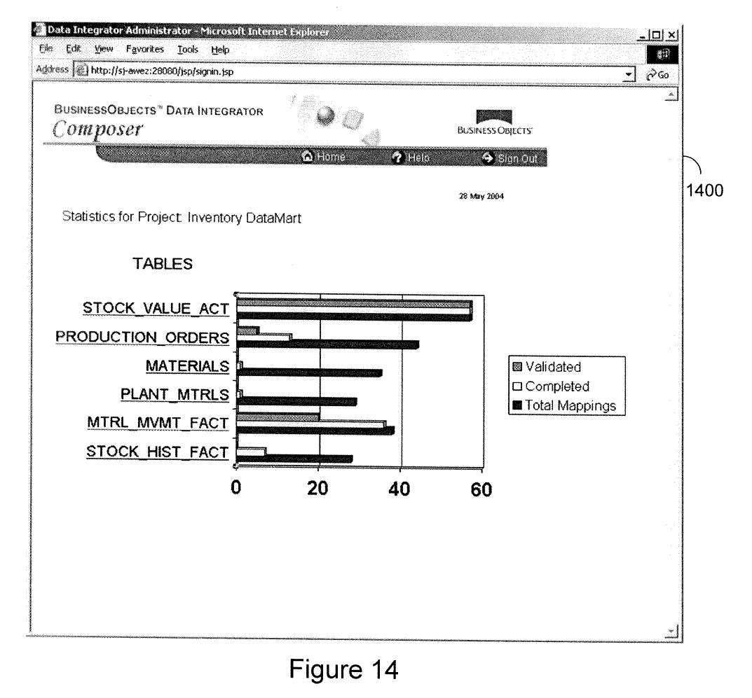

The mapping module 30 may be configured to track the mapping process. For example, as shown in FIG. 14, a GUI 1400 may be supplied to provide mapping statistics. The mapping module 30 may also be configured to supply projection completion statistics. Alternately, a report may be created to describe mappings per table, with details about each column transformation. This information may be provided through a web browser or may be implemented in an application document (e.g., a Word document or an Excel document).

The project specification module 24 may also be used to generate reports. For example, the project specification module 24 may be used to list projects, their basic properties and associated high-level objects, such target data store, source data stores, tasks and supporting documents. The project specification module 24 may also be used to generate reports summarizing the basic properties and imported tables associated with all data stores. Details of a particular data store, e.g., its tables and column information, may also be supplied.

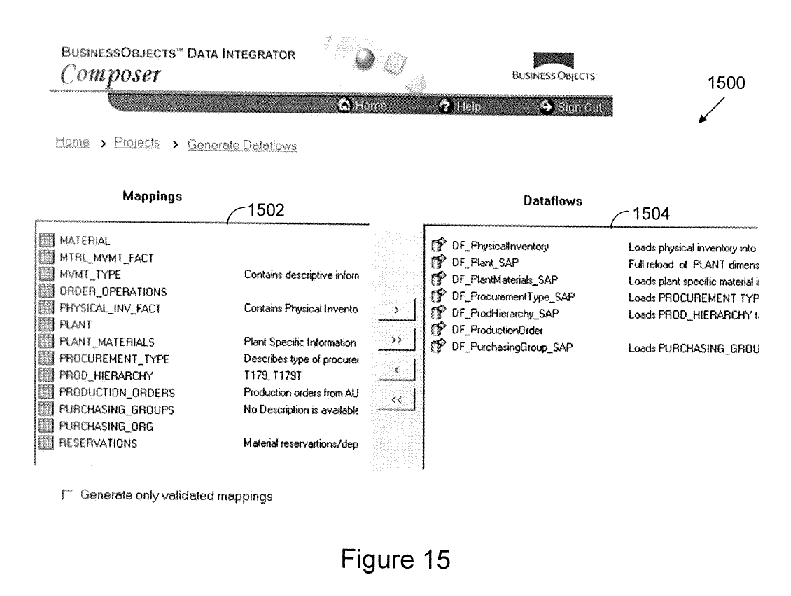

After the mapping operation is completed, the ETL task generator 32 generates an ETL task. By way of example, FIG. 15 illustrates a GUI 1500 associated with the ETL task generator 32. The GUI 1500 illustrates how individual mappings within the mappings pane 1502 may be selected to produce corresponding data flows, which are shown in pane 1504.

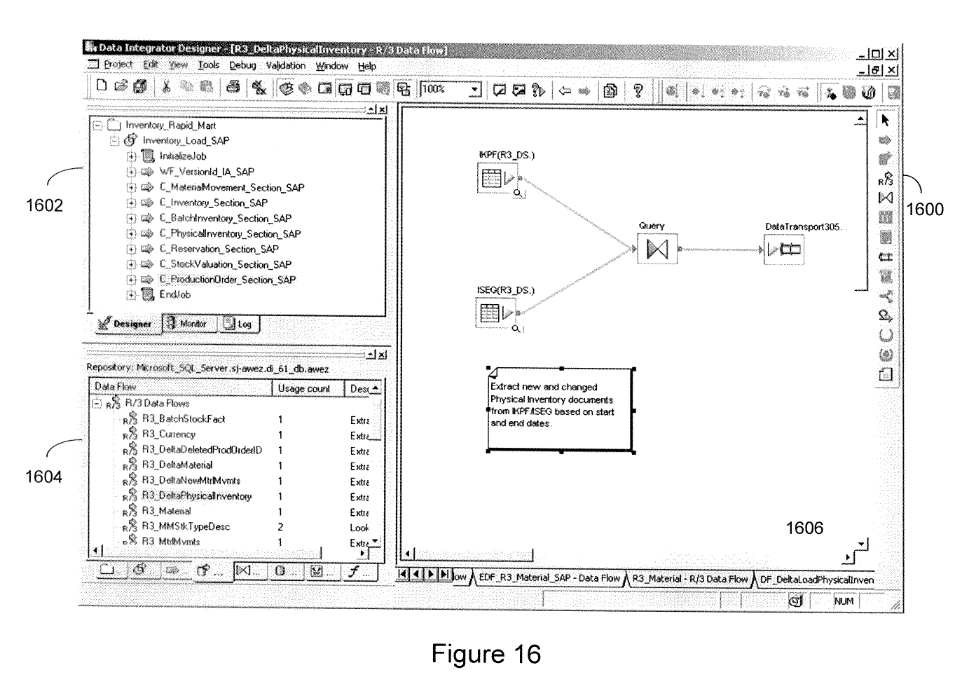

Once the data flows are specified, the ETL task processor 34 may process the task. FIG. 16 illustrates a GUI 1600 associated with an ETL task processor 34. Pane 1602 illustrates data sources, pane 1604 illustrates data flows, and pane 1606 illustrates data source flow through a query to a data source. Regardless of the interface, the ETL task processor operates to capture the mappings and structure of the ETL task to load a data target.

In one embodiment of the invention, data integration jobs are based on source-to-target mappings with a hidden identifier to identify a generated object. With this technique it is possible to easily update generated objects at a later time. This facilitates round trip synchronization of the ETL code with the original design and thereby allows ongoing maintenance of the data warehouse.

When designing mappings involving more than one source table, users can profile the source tables to determine (i) the keys on which the tables should be joined and (ii) the kind of join to be used, e.g., a simple join, a one-way outer join, or a two-way outer-join. Once the relationship has been profiled, the appropriate join condition is generated and is then translated into a data flow.

An embodiment of the invention profiles relational data (e.g., data stored in tables in a relational database) and hierarchical data, such as XML. In the case of hierarchical data, nested tables in XML are treated as a separate mini-table. Validation rules can similarly be derived from XML data.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
accept a specification of an Extraction, Transformation, Load (ETL) task associated with source data;
profile the source data to produce profiled data;
define data conformance rules from the profiled data;
generate mapping rules in accordance with the specification and data conformance rules;
utilize the mapping rules to create an ETL task.

2. The computer readable storage medium of claim 1 wherein the executable instructions to accept a specification include executable instructions to accept the specification of a plurality of heterogeneous data sources forming the source data.

3. The computer readable storage medium of claim 2 wherein the executable instructions to accept a specification include executable instructions to accept the specification of data connections to the plurality of heterogeneous data sources.

4. The computer readable storage medium of claim 1 wherein the executable instructions to accept a specification include executable instructions to accept a collaborative specification defined by a plurality of users.

5. The computer readable storage medium of claim 4 wherein the executable instructions to accept a collaborative specification include executable instructions to accept data source characterization information for each heterogeneous data source.

6. The computer readable storage medium of claim 1 wherein the executable instructions to accept a specification include executable instructions to accept the specification of a data target.

7. The computer readable storage medium of claim 1 further comprising executable instructions to display profiled data reflecting data quality problems.

8. The computer readable storage medium of claim 1 wherein the executable instructions to define data conformance rules include executable instructions to identify columns that are insignificant, duplicate or correlated.

9. The computer readable storage medium of claim 1 wherein the executable instructions to define data conformance rules include executable instructions to determine keys on which tables can be joined and determine join relationships between tables.

10. The computer readable storage medium of claim 1 wherein the executable instructions to generate mapping rules include executable instructions to accept attachments characterizing the mapping rules.

11. The computer readable storage medium of claim 1 wherein the executable instructions to generate mapping rules include executable instructions to specify joins.

12. The computer readable storage medium of claim 1 wherein the executable instructions to generate mapping rules include executable instructions to specify filter conditions.

13. The computer readable storage medium of claim 1 wherein the executable instructions to generate mapping rules include executable instructions to accept expert validation of mapping rules.

14. The computer readable storage medium of claim 1 further comprising executable instructions to supply mapping statistics.

15. The computer readable storage medium of claim 1 further comprising executable instructions to supply project reports.

16. The computer readable storage medium of claim 1 further comprising executable instructions to supply data source reports.

17. The computer readable storage medium of claim 1 wherein the executable instructions to utilize the mapping rules to create an ETL task include executable instructions to create a plurality of dataflow tasks.

18. The computer readable storage medium of claim 1 further comprising executable instructions to process the ETL task to produce a data target.

19. The computer readable storage medium of claim 18 further comprising executable instructions to process the ETL task to produce a data warehouse.

20. The computer readable storage medium of claim 1 further comprising executable instructions to assign an identifier to an object associated with a mapping.
